(19) United States
(12) Patent Application Publication
(10) Pub. No.: US 2016/0144763 A1
(43) Pub. Date: May 26, 2016

(54) EUTECTIC DEVICE FOR A TRANSPORT REFRIGERATION SYSTEM AND METHODS FOR COOLING AND INSTALLING THE EUTECTIC DEVICE

(71) Applicant: THERMO KING CORPORATION, Minneapolis, MN (US)

(72) Inventors: David J. VANDER WOUDE, Farmington, MN (US); Herman H. VIEGAS, Bloomington, MN (US)

(21) Appl. No.: 14/900,059

(22) PCT Filed: Jun. 18, 2014
(86) PCT No.: PCT/US2014/042894

§ 371 Date: Dec. 18, 2015

Related U.S. Application Data
(60) Provisional application No. 61/836,445, filed on Jun. 18, 2013.

(51) Int. Cl. B60P 3/20; B60H 1/00; F25D 23/00; F25D 3/00; F25D 17/02

(52) U.S. Cl. CPC B60P 3/20; F25D 3/005; F25D 17/02; F25D 23/006; B60H 1/005

(57) ABSTRACT

A device and method for cooling an air inside a cargo space by freezing an eutectic solution of an eutectic device. The eutectic device is installed inside a cargo space of a refrigerated transport unit. A cryogen is provided to a cryogen circuit of the eutectic device that is connected to a transport unit. Then the cryogen is circulated through the cryogen circuit, transferring heat from the eutectic medium to the cryogen. This transfer of heat freezes the eutectic medium. The frozen eutectic medium is used to cool a cargo space of a container of the transport unit.

### FIELD

This disclosure generally relates to an eutectic device for a transport refrigeration system (“TRS”) and methods for cooling and installing the eutectic device.

### BACKGROUND

Existing transport refrigeration systems are used to cool containers, trailers, railcars or other transport units (“TU”). A temperature controlled TU (typically referred to as a “refrigerated transport unit”) is commonly used to transport perishable items such as produce and meat products. In such a case, a TRS can be used to condition the air inside a cargo space of the TU, thereby maintaining desired temperature and humidity during transportation or storage. Typically a transport refrigeration unit (“TRU”) is attached to the TU to facilitate a heat exchange between the air inside the cargo space and the air outside of the TU.

### SUMMARY

The embodiments described herein relate generally to a TRS. In particular, the embodiments described herein are directed to an eutectic device of the TRS for cooling an air inside a cargo space of a TU and methods for cooling and installing the eutectic device.

In particular, the embodiments described herein are directed to a method for cooling an eutectic device in a TRS, the eutectic device containing an eutectic medium, and having a cryogen circuit disposed in thermal contact with the eutectic medium. The method comprises directing the flow of a cryogen through the cryogen circuit of the eutectic device, freezing the eutectic medium by transferring heat from the eutectic medium to the cryogen flowing through the cryogen circuit, and then removing the cryogen that is in a gas phase via a gas outlet of the cryogen circuit.

The cryogen circuit may include an evaporator coil. The method can further include transitioning the cryogen from a liquid phase to the gas phase within the evaporator coil.

The method can further include connecting a stationary cryogen tank to an inlet of the cryogen circuit to provide the cryogen to the cryogen circuit.

The method can further include connecting a mobile cryogen tank to an inlet of the cryogen circuit to provide the cryogen to the cryogen circuit.

In an embodiment of the method, directing the flow of the cryogen includes directing the flow of liquid carbon dioxide (CO₂) through the cryogen circuit of the eutectic device.

In an embodiment of the method, directing the flow of the cryogen includes directing the flow of liquid nitrogen (N₂) through the cryogen circuit of the eutectic device.

A method for installing an eutectic device to a TRS includes providing the eutectic device including an eutectic medium, and a cryogen circuit in thermal contact with the eutectic medium, wherein a cryogen flowing through the cryogen circuit is physically separated from the eutectic medium, and connecting the eutectic device to the TRS.

The method for installing the eutectic device can further include connecting a stationary cryogen tank to an inlet of the cryogen circuit to provide the cryogen to the cryogen circuit.

The method for installing the eutectic device can further include connecting a mobile cryogen tank to an inlet of the cryogen circuit to provide the cryogen to the cryogen circuit.

An embodiment of a TRS for controlling refrigeration in a transport unit comprises a cryogen circuit including a fluid inlet, and a gas outlet, the cryogen circuit configured to direct a cryogen from the fluid inlet to the gas outlet, the fluid inlet is configured to connect to a cryogen tank for directing the flow of the cryogen from the cryogen tank to the fluid inlet and then through the cryogen circuit, an eutectic device in thermal contact with the cryogen circuit downstream from the fluid inlet, the eutectic device including an eutectic medium, wherein the thermal contact allows a heat transfer from the eutectic medium to the cryogen flowing through the cryogen circuit, transitioning the cryogen from a liquid phase to a gas phase in the cryogen circuit, and the gas outlet is disposed downstream from the eutectic device to allow the cryogen in the gas phase to exit the cryogen circuit.

The TRS may further include a back pressure regulator connected to the cryogen circuit downstream from the gas outlet.

The TRS may further include a temperature sensor connected to the cryogen circuit downstream from the eutectic device, wherein the temperature sensor is configured to detect a temperature of the cryogen in the cryogen circuit.

In an embodiment, the cryogen includes carbon dioxide (CO₂).

In an embodiment, the cryogen is carbon dioxide (CO₂).

In another embodiment, the cryogen includes nitrogen (N₂).

In another embodiment, the cryogen is nitrogen (N₂).

### BRIEF DESCRIPTION OF THE DRAWINGS

Referring now to the drawings in which like reference numbers represent corresponding parts throughout.

FIG. 1 illustrates a side cutaway view of a refrigerated transport unit attached to a tractor, according to an embodiment.

FIG. 2 illustrates an eutectic device for a TRS according to an embodiment.

FIG. 3 shows a flowchart of a method for cooling an eutectic device housed within a TU, according to an embodiment.

### DETAILED DESCRIPTION

The embodiments described herein are directed to a TRS. More particularly, the embodiments relate to an eutectic device of the TRS and methods for cooling and installing the eutectic device.

References are made to the accompanying drawings that form a part hereof, and in which is shown by way of illustration of the embodiments in which the methods and systems described herein may be practiced. The term “refrigerated transport unit” generally refers to, for example, a conditioned trailer, container, railcars or other type of transport unit, etc. The term “transport refrigeration system” or “TRS” refers to a refrigeration system for controlling the refrigeration of an air conditioned space of the refrigerated transport unit.

It will be appreciated that the embodiments described herein may be used in any suitable transport unit such as a ship or rail board container, an air cargo cabin, an over the road truck cabin, etc.

FIG. 1 illustrates a side view of a refrigerated transport unit 10 attached to a tractor 11. The refrigerated transport unit 10 includes a transport unit 12 and a TRS 14 that includes an eutectic device 16. The transport unit 12 includes a bulkhead 17 which separates the eutectic device 16 from a cargo space 18.

The TRS 14 is configured to transfer heat between the cargo space 18 and the eutectic device 16. The eutectic device 16 is in communication with the cargo space 18 and controls the temperature in the cargo space 18. FIG. 1 shows the eutectic device 16 positioned near a front wall of the transport unit 12, in front of the bulkhead 17 (e.g., between a front wall 19 of the transport unit 12 and the bulkhead 17 in the transport unit 12). FIG. 1 shows the TRS 14 including a blower fan 20 for blowing air cooled by the TRS 14 towards rear of the cargo space 18. In other embodiments, the blower fan 20 may be positioned so that the cooled air is blown towards the front of the cargo space 18. For example, the eutectic device 16 (or the plates of the eutectic device 16) can be connected to a ceiling of the cargo space 18. For example, in such configuration, a blower fan may not be needed because air cooled by the eutectic device 16 would naturally flow downward from the ceiling of the cargo space 18.

In FIG. 1, the eutectic device 16 is shown to be cold plates. However, the eutectic device 16 can be one or more cold plates, tubes, or combinations thereof. The eutectic device 16 contains an eutectic medium. The eutectic medium becomes solid when cooled (e.g., freezes) and then absorbs heat to transition to a liquid. The eutectic medium can include, for example, sodium chloride solution, calcium chloride solution, etc.

The TRS 14 optionally includes a cryogen tank 22. The cryogen tank 22 is connected to the eutectic device 16 to direct a cryogen from the cryogen tank 22 through the eutectic device 16. The cryogen tank 22 can be connected to the transport unit 12 or the tractor 11, so that the cryogen tank 22 can provide the cryogen to the eutectic device 16 for freezing the eutectic medium as desired or needed, while in transit or when away from a station.

In one embodiment, the eutectic device 16 does not require power from a generator set (hereafter referred to as “genset”) to condition the cargo space 18 of the transport unit 12. Accordingly, after the eutectic medium has been frozen, the TRS 14 having the eutectic device 16 can cool the cargo space 18 without generating any substantial noise, or any noise. Thus, advantageously, the eutectic device 16 can provide near silent cooling to the cargo space 18. Additionally, the TRS 14 having the eutectic device 16 can cool the cargo space 18 with no power, or very little power (e.g., low amount of power for running the blower fan 20).

An embodiment of the TRS 14 does not include a mechanical refrigeration system, because the TRS 14 can cool the cargo space 18 without a need to run the mechanical refrigeration system. Thus significantly reducing cost, weight, noise production, emissions, and/or power consumption as described above associated with a conventional mechanical refrigeration unit.

An embodiment of the TRS 14 does not include a condensing unit, because the TRS 14 can cool the cargo space 18 without a need of the condensing unit.

An embodiment of the TRS 14 does not include both of the mechanical refrigeration system and the condensing unit. Thus significantly reducing noise production, emissions, and power consumption as described above associated with a conventional mechanical refrigeration unit.

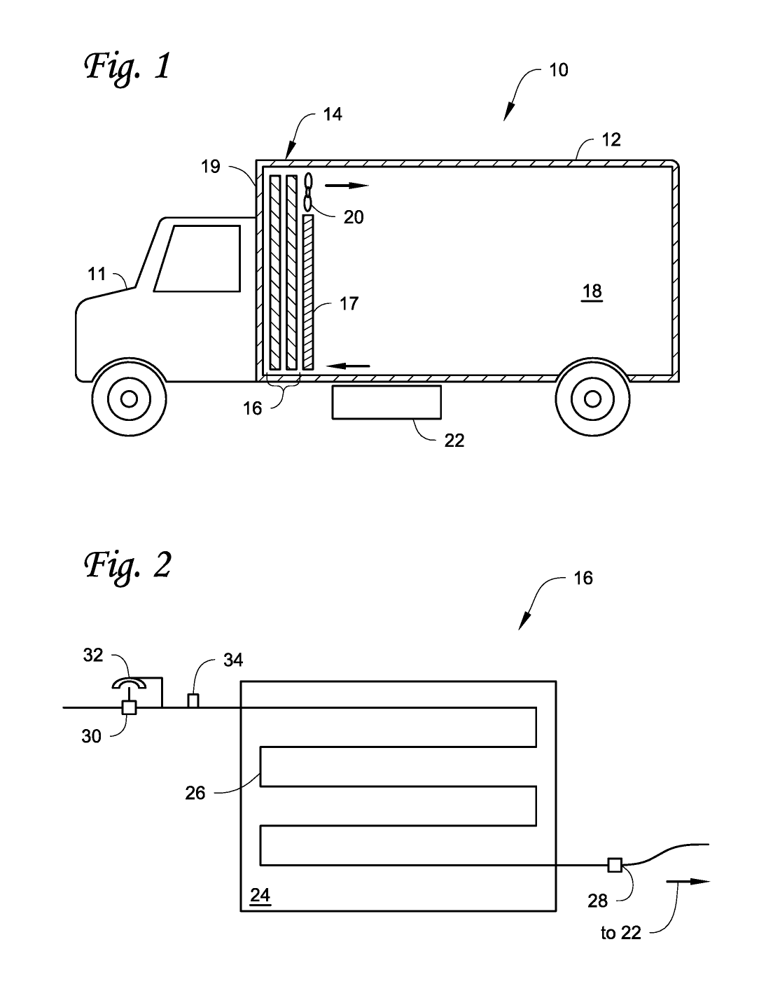

FIG. 2 shows an embodiment of the eutectic device 16. The eutectic device 16 contains the eutectic medium 24 therein. The eutectic medium 24 becomes solid when cooled (e.g., freezes) and then absorbs heat to transition to the liquid phase.

The eutectic device 16 includes a cryogen circuit 26 for directing a cryogen therethrough. The cryogen circuit 26 has a cryogen inlet 28 and a gas outlet 30. For example, the cryogen inlet 28 has a connector for connecting to a cryogen tank (e.g., the cryogen tank 22 shown in FIG. 1).

The cryogen circuit 26 allows the cryogen to flow within the eutectic device 16 without physically mixing with the eutectic medium 24. The cryogen circuit 26 allows the cryogen to have thermal contact with the eutectic medium 24, so that heat can transfer from the eutectic medium 24 to the cryogen flowing through the cryogen circuit 26. When heat is transferred from the eutectic medium 24 to the cryogen, the eutectic medium 24 becomes frozen and the cryogen transitions from a liquid phase to a gas phase.

Thus, when the cryogen is introduced into the cryogen circuit 26 via the cryogen inlet 28, the cryogen is in a liquid phase. When the cryogen leaves the cryogen circuit 26 via the gas outlet 30, the cryogen is in a gas phase. The gas outlet 30 is disposed outside the container, so that the cryogen gas does not enter a cargo space (e.g., the cargo space 18 shown in FIG. 1). The cryogen circuit 26 includes an evaporator coil, wherein transitioning the liquid phase of the cryogen to the gas phase of the cryogen occurs at the evaporator coil.

The eutectic device 16 uses the cryogen to freeze the eutectic medium 24. Examples of the cryogen are, but are not limited to, carbon dioxide (CO₂) and nitrogen (N₂). Thus, when the cryogen is introduced into the cryogen circuit 26 via the cryogen inlet 28, the cryogen is in a liquid phase, such as liquid carbon dioxide or liquid nitrogen. When the cryogen leaves the cryogen circuit 26 via the gas outlet 30, the cryogen is in a gas phase, such as carbon dioxide gas or nitrogen gas.

The frozen eutectic medium 24 then transfers heat to a plate or a cylinder of the eutectic device, which cools the air inside the cargo space of the container. The cryogen circuit 26 can also include a back pressure regulator 32 at the gas outlet 30 that prevents back pressure issues. For example, when the cryogen is CO₂, the back pressure regulator 32 prevents pressure from dropping too low, which would cause dry ice (solid phase of CO₂) formation. Dry ice can block the flow of the cryogen and stop the cooling process. This dry ice formation issue does not exist when the cryogen is N₂, so back pressure regulator 32 is not needed for embodiments that use N₂ as the cryogen.

The cryogen circuit 26 can also include a sensor 34 that can detect a condition of the cryogen circuit 26, wherein the condition can be, but not limited to, temperature.

In some embodiments, the eutectic device 16 can operate without a compressor unit and/or a condensing unit. The term condensing unit is used herein to describe a separate and independent device from a condenser of the mechanical refrigeration system. That is, the mechanical refrigeration system includes the condenser. The condensing unit is a separate and independent device from the mechanical refrigeration system. Accordingly, the eutectic device 16 which can operate without the condensing unit does not preclude the eutectic device 16 being operable with the mechanical refrigeration system (which includes the condenser). In an embodiment, the cryogen circuit 26 does not include a blower.

An embodiment of a method for installing the eutectic device 16 to the TRS 14 includes providing the eutectic device 16 containing the eutectic medium 24, and the cryogen circuit 26, and then connecting the eutectic device 16 to the TRS 14. In particular, the method can include providing the eutectic device 16 at one side of a container so as to separate the eutectic device 16 from the cargo spaces.

Optionally, the method can further include connecting a stationary cryogen tank to the cryogen inlet 28 to provide the cryogen to the cryogen circuit 26. The method can further include connecting a mobile cryogen tank (e.g., the cryogen tank 22 shown in FIG. 1) to the cryogen inlet 28 to provide the cryogen to the cryogen circuit 26.

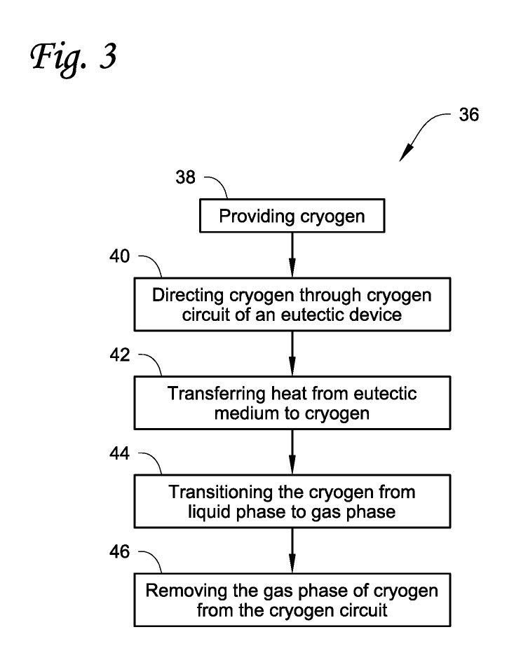

FIG. 3 shows an embodiment of a method 36 for cooling an eutectic device housed within a transport unit. The method 36 includes providing a cryogen 38 to the eutectic device, such as, by connecting a cryogen circuit to a cryogen tank (e.g., the cryogen tank 22 shown in FIG. 1) that is mobile with the transport unit or one that is separable from the transport unit. The method 36 includes directing the cryogen 40 through the cryogen circuit of the eutectic device. Then, transferring heat 42 from an eutectic medium stored within the eutectic device to the cryogen flowing in the cryogen circuit, causing the eutectic medium to freeze. The heat transfer causes a phase transition 44 of the cryogen, from a liquid phase to a gas phase, in the cryogen circuit. Then the method 36 includes removing the cryogen 46 that is in a gas phase via a gas outlet of the cryogen circuit.

### Aspects

It is noted that any of the features in aspects 1-6, 7-9 and 10-14 can be combined.
Aspect 1. A method for cooling an eutectic device in a transport refrigeration system (TRS), the eutectic device containing an eutectic medium, and having a cryogen circuit disposed in thermal contact with the eutectic medium, the method comprising:

directing the flow of a cryogen through the cryogen circuit of the eutectic device;

cooling the eutectic medium by transferring heat from the eutectic medium to the cryogen flowing through the cryogen circuit; and

removing the cryogen that is in a gas phase via a gas outlet of the cryogen circuit.
Aspect 2. The method according to aspect 1, further comprising transitioning the cryogen from a liquid phase to the gas phase within an evaporator coil of the cryogen circuit.
Aspect 3. The method according to any of the aspects 1-2, further comprising directing the cryogen from a stationary cryogen tank to an inlet of the cryogen circuit to provide the cryogen to the cryogen circuit.
Aspect 4. The method according to any of the aspects 1-3, further comprising directing the cryogen from a mobile cryogen tank to an inlet of the cryogen circuit to provide the cryogen to the cryogen circuit.
Aspect 5. The method according to any of the aspects 1-4, wherein directing the flow of the cryogen includes directing the flow of liquid carbon dioxide (CO₂) through the cryogen circuit of the eutectic device.
Aspect 6. The method according to any of the aspects 1-5, wherein directing the flow of the cryogen includes directing the flow of liquid nitrogen (N₂) through the cryogen circuit of the eutectic device.
Aspect 7. A method for installing an eutectic device to a transport refrigeration system (TRS), the method comprising:

providing the eutectic device including an eutectic medium, and a cryogen circuit in thermal contact with the eutectic medium, wherein a cryogen flowing through the cryogen circuit is physically separated from the eutectic medium; and

connecting the eutectic device to the TRS.
Aspect 8. The method according to aspect 7, further comprising connecting a stationary cryogen tank to an inlet of the cryogen circuit to provide the cryogen to the cryogen circuit.
Aspect 9. The method according to any of the aspects 7-8, further comprising connecting a mobile cryogen tank to an inlet of the cryogen circuit to provide the cryogen to the cryogen circuit.
Aspect 10. A transport refrigeration system (TRS) for controlling refrigeration in a transport unit, comprising:

a cryogen circuit including a fluid inlet, and a gas outlet, the cryogen circuit configured to direct a cryogen from the fluid inlet to the gas outlet, the fluid inlet is configured to connect to a cryogen tank for directing the flow of the cryogen from the cryogen tank to the fluid inlet and then through the cryogen circuit;

an eutectic device in thermal contact with the cryogen circuit downstream from the fluid inlet, the eutectic device including an eutectic medium,

wherein the thermal contact allows a heat transfer from the eutectic medium to the cryogen flowing through the cryogen circuit, transitioning the cryogen from a liquid phase to a gas phase in the cryogen circuit, and

the gas outlet is disposed downstream from the eutectic device to allow the cryogen in the gas phase to exit the cryogen circuit.
Aspect 11. The transport refrigeration system (TRS) according to aspect 10, further comprising a back pressure regulator connected to the cryogen circuit downstream from the gas outlet, wherein the back pressure regulator is configured to prevent a back pressure issue.
Aspect 12. The transport refrigeration system (TRS) according to any of the aspects 10-11, further comprising a temperature sensor connected to the cryogen circuit downstream from the eutectic device, wherein the temperature sensor is configured to detect a temperature of the cryogen in the cryogen circuit.
Aspect 13. The transport refrigeration system (TRS) according to any of the aspects 10-12, wherein the cryogen includes carbon dioxide (CO₂).
Aspect 14. The transport refrigeration system (TRS) according to any of the aspects 10-13, wherein the cryogen includes nitrogen (N₂).

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

What is claimed is:

1. A method for cooling an eutectic device in a transport refrigeration system (TRS), the eutectic device containing an eutectic medium, and having a cryogen circuit disposed in thermal contact with the eutectic medium, the method comprising:
directing the flow of a cryogen through the cryogen circuit of the eutectic device;
cooling the eutectic medium by transferring heat from the eutectic medium to the cryogen flowing through the cryogen circuit; and
removing the cryogen that is in a gas phase via a gas outlet of the cryogen circuit.

2. The method according to claim 1, further comprising transitioning the cryogen from a liquid phase to the gas phase within an evaporator coil of the cryogen circuit.

3. The method according to claim 1, further comprising directing the cryogen from a stationary cryogen tank to an inlet of the cryogen circuit to provide the cryogen to the cryogen circuit.

4. The method according to claim 1, further comprising directing the cryogen from a mobile cryogen tank to an inlet of the cryogen circuit to provide the cryogen to the cryogen circuit.

5. The method according to claim 4, wherein directing the flow of the cryogen includes directing the flow of liquid carbon dioxide (CO₂) through the cryogen circuit of the eutectic device.

6. The method according to claim 4, wherein directing the flow of the cryogen includes directing the flow of liquid nitrogen (N₂) through the cryogen circuit of the eutectic device.

7. A method for installing an eutectic device to a transport refrigeration system (TRS), the method comprising:
providing the eutectic device including an eutectic medium, and a cryogen circuit in thermal contact with the eutectic medium, wherein a cryogen flowing through the cryogen circuit is physically separated from the eutectic medium; and
connecting the eutectic device to the TRS.

8. The method according to claim 7, further comprising connecting a stationary cryogen tank to an inlet of the cryogen circuit to provide the cryogen to the cryogen circuit.

9. The method according to claim 7, further comprising connecting a mobile cryogen tank to an inlet of the cryogen circuit to provide the cryogen to the cryogen circuit.

10. A transport refrigeration system (TRS) for controlling refrigeration in a transport unit, comprising:
a cryogen circuit including a fluid inlet, and a gas outlet, the cryogen circuit configured to direct a cryogen from the fluid inlet to the gas outlet, the fluid inlet is configured to connect to a cryogen tank for directing the flow of the cryogen from the cryogen tank to the fluid inlet and then through the cryogen circuit;
an eutectic device in thermal contact with the cryogen circuit downstream from the fluid inlet, the eutectic device including an eutectic medium,
wherein the thermal contact allows a heat transfer from the eutectic medium to the cryogen flowing through the cryogen circuit, transitioning the cryogen from a liquid phase to a gas phase in the cryogen circuit, and
the gas outlet is disposed downstream from the eutectic device to allow the cryogen in the gas phase to exit the cryogen circuit.

11. The transport refrigeration system (TRS) according to claim 10, further comprising a back pressure regulator connected to the cryogen circuit downstream from the gas outlet, wherein the back pressure regulator is configured to prevent a back pressure issue.

12. The transport refrigeration system (TRS) according to claim 10, further comprising a temperature sensor connected to the cryogen circuit downstream from the eutectic device, wherein the temperature sensor is configured to detect a temperature of the cryogen in the cryogen circuit.

13. The transport refrigeration system (TRS) according to claim 10, wherein the cryogen includes carbon dioxide (CO₂).

14. The transport refrigeration system (TRS) according to claim 10, wherein the cryogen includes nitrogen (N₂).
